(19) United States
(12) Patent Application Publication
(10) Pub. No.: US 2003/0199351 A1
(43) Pub. Date: Oct. 23, 2003

(54) Interchangeable motorcycle sprocket ring

(76) Inventor: David J. Nichols, Atascadero, CA (US)

Correspondence Address: Donald W. Meeker, 924 East Ocean Front, #E, Newport Beach, CA, 92661, US

(21) Appl. No.: 10/128,003

(22) Filed: Apr. 22, 2002

(51) Int. Cl. F16H 55/12; F16H 55/46

(52) U.S. Cl. 474/160; 474/152; 474/95; 474/161

(57) ABSTRACT

A sprocket ring has outwardly protruding spaced teeth to engage the motorcycle drive chain and an inner circular flange to interconnect with the sprocket hub. The sprocket hub has an outer circular flange to interconnect with the sprocket ring. Mating holes in the flanges receive bolts therethrough to interconnect the ring and the hub.

### BACKGROUND OF THE INVENTION

1. Field of the Invention

The present invention relates to motorcycle sprockets and in particular to a two-piece motorcycle sprocket with an interchangeable ring, which can have different teeth configurations and be of a different material than that of the hub.

2. Description of the Prior Art

Motorcycle sprockets, particularly for high performance, can wear out quickly if they are the light weight types of aluminum sprockets used in high performance motorcycle riding. Replacing the entire sprocket can be expensive. Steel sprockets wear out less rapidly but are too heavy for high performance motorcycle riding. A hybrid sprocket would make sense in this case.

Changing the size and number of teeth on the sprocket affects the gearing ratio and can be advantageous for varying the performance of the bike for different types of uses. For cross country use, a smaller sprocket produces higher speeds. For closed-course competition use, a larger sprocket produces quick acceleration. Easy and inexpensive changeability of the size and number of teeth on a sprocket would be desirable.

A number of prior patents have addressed the sprocket situation, but not solved the problems mentioned.

U.S. Pat. No. 6,213,238, issued Apr. 10, 2001 to Buell, provides a motorcycle sprocket assembly which is fabricated in parts by a less expensive manufacturing process. The patent mentions that the material may be aluminum or steel, but not that an aluminum hub be combined with a steel ring.

U.S. Pat. No. 3,416,385, issued Dec. 17, 1968 to Schenk, shows a sprocket assembly having two thin circular plates sandwiched together with two flanges on the circular perimeter forming a channel for the chain to move within. A separate hub and separate toothed ring are inserted between the two circular plates.

U.S. Pat. No. 338,961, issued Mar. 30, 1886 to Hart, claims a means of manufacturing a combined pinion and ratchet with a toothed ring attached to a ratchet hub each formed separately.

U.S. Pat. No. 3,730,009, issued May 1, 1973 to Mead, describes a composite drive wheel having a stamped metal plate and molded metal reinforced plastic teeth.

U.S. Pat. No. 5,224,903, issued Jul. 6, 1993 to Langhof, discloses a chain wheel having a shrink ring made of polymer material attached to the outside of the metal sprocket for receiving the brunt of the contact of the chain with the sprocket to reduce noise.

U.S. Pat. No. 4,589,860, issued May 20, 1986 to Brandenstein, indicates a gear and method for making a gear having a body of cast material having a ring plate of metal embedded in the web section joining the hub and gear sections.

None of the prior patents provide a combined and interchangeable steel/aluminum sprocket having a lightweight aluminum hub and a durable steel ring which is interchangeable with varying numbers of teeth to change the gearing ratio.

### SUMMARY OF THE INVENTION

An object of the present invention is to provide a two-piece motorcycle sprocket with a separable tooth ring removably attachable to a hub, so that it is easy and inexpensive to change the size or number of teeth of the sprocket and thereby change the gearing ratio by merely changing the outside ring containing the teeth.

Another object of the present invention is to provide a hybrid motorcycle sprocket with an outside steel toothed ring for greater strength and a longer use period with an inner hub of aluminum for lighter weight necessary to high performance motorcycle riding.

In brief, a durable steel ring, with a variable number of teeth on the ring, is removably mountable on a lightweight aluminum hub to form a lightweight durable motorcycle sprocket with ease and low cost interchangeability.

The toothed ring is removably mounted on the hub by bolting the two overlapping flanges of the ring and hub together or by a tongue and groove type interlocking connection between the ring and the hub.

An advantage of the present invention is that it provides an inexpensive means to change sprockets by just changing the toothed ring.

Another advantage of the present invention is that it allows quick and easy and inexpensive interchangeability of sprockets with different sizes and different numbers of teeth for changing gearing ratios.

An additional advantage of the present invention is that it provides for a hybrid sprocket which is both lightweight and durable.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a plan view of the sprocket ring having outer teeth and spaced holes in an inner flange ring for receiving bolts to connect to the hub;

FIG. 1A is a cross-sectional view of the sprocket ring of FIG. 1;

FIG. 2 is a plan view of the sprocket hub with spaced holes in an outer flange ring for receiving bolts to connect to the ring;

FIG. 2A is a cross-sectional view of the sprocket hub of FIG. 2.

### BEST MODE FOR CARRYING OUT THE INVENTION

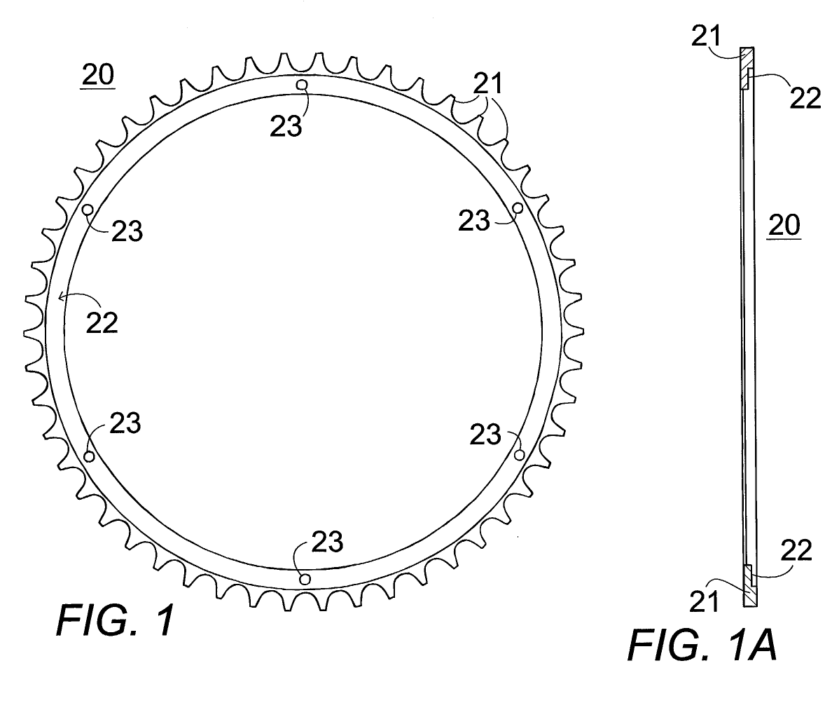

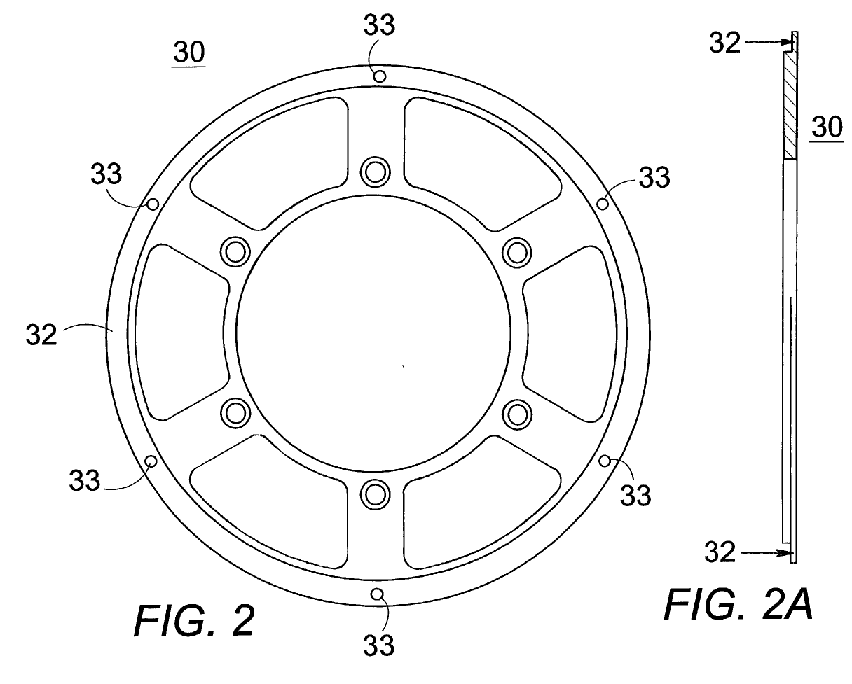

In FIGS. 1, 1A, 2, and 2A, a two-piece sprocket for a motorcycle comprises a sprocket ring 20 having outer spaced teeth 21 extending outwardly from the ring for engaging a motorcycle drive chain and having an inner circular flange 22 provided with spaced holes 23 for receiving bolts therethrough and a sprocket hub 30 having an outer circular flange 32 capable of mating with the inner circular flange 22 of the sprocket ring 20 with mating spaced holes 23 and 33 in the ring and hub respectively for receiving bolts therethrough to interconnect the sprocket ring to the sprocket hub.

Any of a number of different sprocket rings 20 of different sizes and having different numbers of teeth 21 are capable of being attached to the sprocket hub 30 to change the gearing ratio.

The sprocket ring 20 and the sprocket hub 30 may be fabricated of different materials to create a hybrid sprocket.

For greater durability to prolong the life of the sprocket ring and help prevent breakage, the sprocket ring 20 is preferably fabricated of steel.

For lighter weight, the sprocket hub 30 is preferably fabricated of aluminum.

It is understood that the preceding description is given merely by way of illustration and not in limitation of the invention and that various modifications may be made thereto without departing from the spirit of the invention as claimed.

What is claimed is:

1. A two-piece sprocket for a motorcycle, the sprocket comprising:
a sprocket ring having outer spaced teeth extending outwardly from the ring for engaging a motorcycle drive chain and having an inner circular flange provided with spaced holes for receiving bolts therethrough;
a sprocket hub having an outer circular flange capable of mating with the inner circular flange of the sprocket ring with mating spaced holes for receiving bolts therethrough to interconnect the sprocket ring to the sprocket hub.

2. The two-piece sprocket of claim 1 wherein any of a number of different sprocket rings of different sizes and having different numbers of teeth are capable of being attached to the sprocket hub to change the gearing ratio.

3. The two-piece sprocket of claim 1 wherein the sprocket ring and the sprocket hub are fabricated of different materials to create a hybrid sprocket.

4. The two-piece sprocket of claim 3 wherein the sprocket ring is fabricated of steel.

5. The two-piece sprocket of claim 3 wherein the sprocket hub is fabricated of aluminum.
